(19) United States
(12) Patent Application Publication
(10) Pub. No.: US 2026/0052074 A1
(43) Pub. Date: Feb. 19, 2026

(54) CONTROL INFORMATION REPORTING TEST FRAMEWORK

(71) Applicant: QUALCOMM Incorporated, San Diego, CA (US)

(72) Inventors: Chu-Hsiang HUANG, San Diego, CA (US); Jae Ho RYU, San Diego, CA (US); Chenxi HAO, Beijing (CN); Changhwan PARK, San Diego, CA (US); Taesang YOO, San Diego, CA (US); Carlos CABRERA MERCADER, Cardiff, CA (US); Jay Kumar SUNDARARAJAN, San Diego, CA (US); Bin HAN, Beijing (CN); Valentin Alexandru GHEORGHIU, Yokohama-shi (JP)

(21) Appl. No.: 19/103,811

(22) PCT Filed: Apr. 3, 2023
(86) PCT No.: PCT/CN2023/085881

§ 371 Date: Feb. 13, 2025

(30) Foreign Application Priority Data
Oct. 28, 2022 (WO) PCT/CN2022/12198

(51) Int. Cl. H04L 41/16; H04B 7/06

(52) U.S. Cl. CPC H04L 41/16; H04B 7/0626; H04B 7/0639

(57) ABSTRACT

An apparatus, method and computer-readable media are disclosed for performing wireless communications. For example, a first network entity associated with a test equipment vendor can receive information specifying at least one of a type of machine learning model to use for a machine learning decoder, one or more parameters for the machine learning decoder, or one or more key performance indicators for the machine learning decoder. The first network entity can receive a representation of control information from a second network entity. The first network entity can further process, using the machine learning decoder configured based on the received information, the representation of the control information to generate a reconstruction of the control information.

### FIELD

The present disclosure generally relates to machine learning (ML) systems for wireless communications. For example, aspects of the present disclosure relate to systems and techniques for providing a test framework for testing ML-based control information reporting for wireless communication systems.

### BACKGROUND

Wireless communications systems are deployed to provide various telecommunications and data services, including telephony, video, data, messaging, and broadcasts. Broadband wireless communications systems have developed through various generations, including a first-generation analog wireless phone service (1G), a second-generation (2G) digital wireless phone service (including interim 2.5G networks), a third-generation (3G) high speed data, Internet-capable wireless device, and a fourth-generation (4G) service (e.g., Long-Term Evolution (LTE), WiMax). Examples of wireless communications systems include code division multiple access (CDMA) systems, time division multiple access (TDMA) systems, frequency division multiple access (FDMA) systems, orthogonal frequency division multiple access (OFDMA) systems, Global System for Mobile communication (GSM) systems, etc. Other wireless communications technologies include 802.11 Wi-Fi, Bluetooth, among others.

A fifth-generation (5G) mobile standard calls for higher data transfer speeds, greater number of connections, and better coverage, among other improvements. The 5G standard (also referred to as “New Radio” or “NR”), according to Next Generation Mobile Networks Alliance, is designed to provide data rates of several tens of megabits per second to each of tens of thousands of users, with 1 gigabit per second to tens of workers on an office floor. Several hundreds of thousands of simultaneous connections should be supported in order to support large sensor deployments. Artificial intelligence (AI) and ML-based algorithms may be incorporated into the 5G and future standards to improve telecommunications and data services.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

In the 3rd Generation Partnership Project (3GPP) radio access network 4 (RAN4) channel state information (CSI) reporting tests, test equipment (TE) uses CSI reports from one or more user equipment (UEs) for precoding matrix indicator (PMI), modulation and coding scheme (MCS), and rank selection according to the procedures in the 3GPP RAN1 and RAN4 specifications. In some cases, artificial intelligence and machine learning are used to determine control information (e.g., CSI or channel state feedback (CSF)), where a machine learning (ML)-based decoder (e.g., a decoder neural network model) in the TE can be used to derive implicit or explicit CSI information from a representation (e.g., latent representation) of the CSI reported from UE. However, a machine learning based decoder is not explicitly specified in the RAN1 specification. The impact of machine learning based decoders on throughput and/or Block Error Rate (BLER) should be considered when defining RAN4 CSI reporting test requirements for such machine learning based decoders. Further, specifications for machine learning based decoders implemented by TE should be included in the RAN4 CSI reporting test definition to ensure the effectiveness of RAN4 CSI reporting test from the perspective of verifying UE performance.

Systems and techniques are described herein for providing a test framework for testing ML-based control information (e.g., CSI) reporting for wireless communication systems. For instance, the systems and techniques can provide a CSI or CSF reporting test framework for ML-based CSI. In some cases, the systems and techniques can utilize one or more data collection techniques (e.g., RAN4 data collection) for performing validation procedures for one or more reference decoders of test equipment (TE) that are trained to generate reconstructed control information (e.g., reconstructed CSI or CSF).

The systems and techniques can provide specifications for one or more reference decoders, which can be included in the 3GPP RAN4 Specification for the one or more reference decoders. For instance, the RAN4 Specification can be modified to specify one or more of the machine learning model(s) (e.g., neural network model(s)) to use for one or more reference decoder(s), the associated parameters (e.g., weights, biases, and/or other parameters) for the reference decoder(s), key performance indicator (KPI) criterion(s) associated with the machine learning model(s) for ensuring the quality of the machine learning model(s) meets quality requirements, or any combination thereof. In some cases, the machine learning model(s) (e.g., the neural network model(s)), the associated parameters, and/or the KPI criterion(s) can be determined based on the data collected using the data collection techniques noted above.

In some aspects, the systems and techniques provide solutions for conducting UE performance verification (e.g., to verify the performance of an ML-based encoder on the UE), such as by performing a PMI test procedure to verify throughput gain of ML-CSI based precoding matrix determination as compared to reference precoding matrix determination or by performing a joint rank indicator (RI)-PMI (RI/PMI) test procedure to verify throughput gain of an ML-CSI based {rank, precoding matrix} determination versus a reference {rank, precoding matrix} determination. The use of brackets “{ }” herein indicates that any combination of elements in the brackets can be used to form a configuration or a profile (e.g., {rank 1, precoding matrix 1}, {rank 2, precoding matrix 1}, {rank 2, precoding matrix 2}, etc.).

In one illustrative example, a method of wireless communication at a first network entity associated with a test equipment vendor is provided. The method can include: receiving, at the first network entity, information specifying at least one of a type of machine learning model to use for a machine learning decoder, one or more parameters for the machine learning decoder, or one or more key performance indicators for the machine learning decoder; receiving, at the first network entity, a representation of control information from a second network entity; and processing, using the machine learning decoder configured based on the received information, the representation of the control information to generate a reconstruction of the control information.

In another example, a first network entity associated with a test equipment vendor is provided. The first network entity can include at least one memory and at least one processor (e.g., configured in circuitry) coupled to the at least one memory and configured to: receive information specifying at least one of a type of machine learning model to use for a machine learning decoder, one or more parameters for the machine learning decoder, or one or more key performance indicators for the machine learning decoder; receive a representation of control information from a second network entity; and process, using the machine learning decoder configured based on the received information, the representation of the control information to generate a reconstruction of the control information.

A non-transitory computer-readable storage medium of a first network entity is provided that includes instructions stored thereon which, when executed by at least one processor, causes the at least one processor to: receive information specifying at least one of a type of machine learning model to use for a machine learning decoder, one or more parameters for the machine learning decoder, or one or more key performance indicators for the machine learning decoder; receive a representation of control information from a second network entity; and process, using the machine learning decoder configured based on the received information, the representation of the control information to generate a reconstruction of the control information.

A first network entity for wireless communications is provided that includes: means for receiving information specifying at least one of a type of machine learning model to use for a machine learning decoder, one or more parameters for the machine learning decoder, or one or more key performance indicators for the machine learning decoder; means for receiving a representation of control information from a second network entity; and means for processing, using the machine learning decoder configured based on the received information, the representation of the control information to generate a reconstruction of the control information.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

Other objects and advantages associated with the aspects disclosed herein will be apparent to those skilled in the art based on the accompanying drawings and detailed description.

### BRIEF DESCRIPTION OF THE DRA WINGS

Examples of various implementations are described in detail below with reference to the following figures:

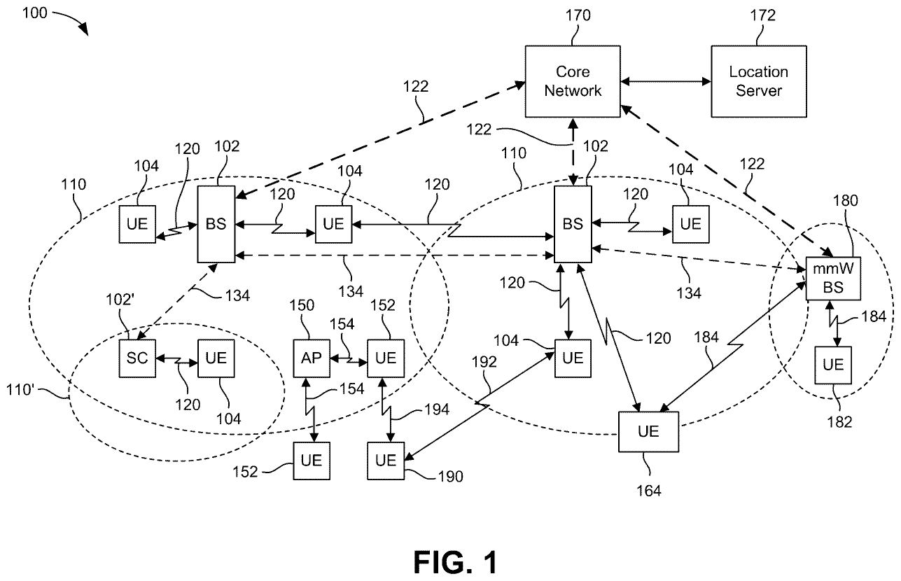

FIG. 1 is a block diagram illustrating an example of a wireless communication network, in accordance with some examples;

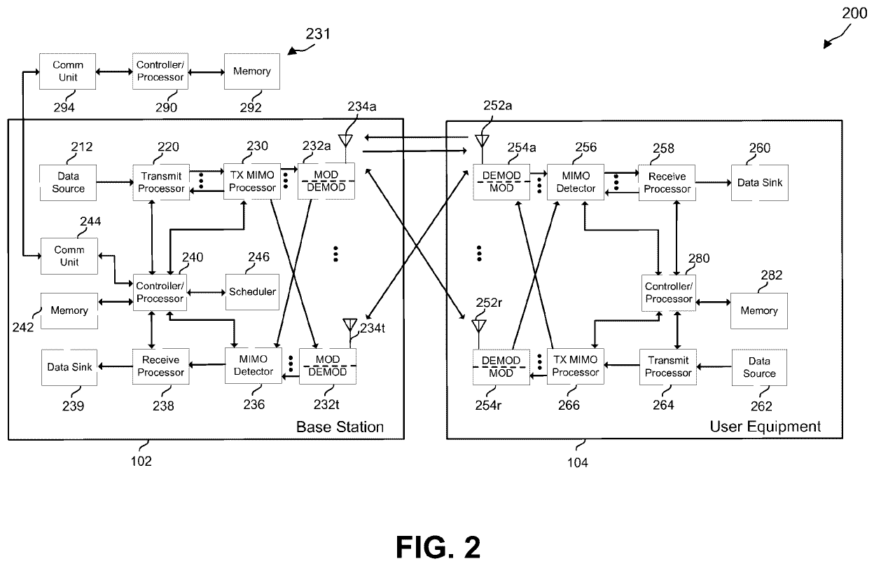

FIG. 2 is a diagram illustrating a design of a base station and a User Equipment (UE) device that enable transmission and processing of signals exchanged between the UE and the base station, in accordance with some examples;

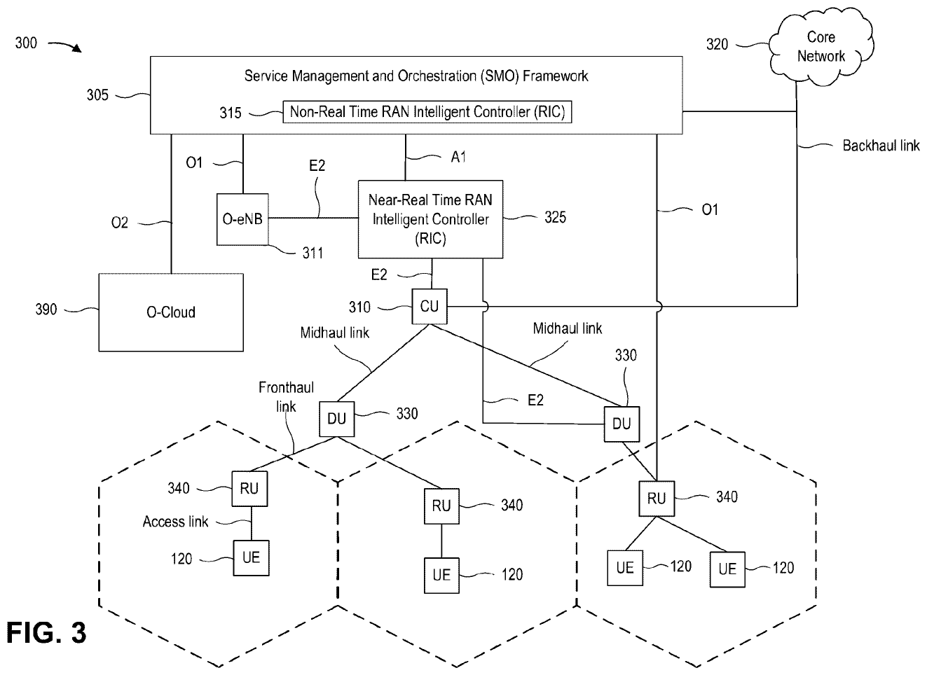

FIG. 3 is a diagram illustrating an example of a disaggregated base station, in accordance with some examples;

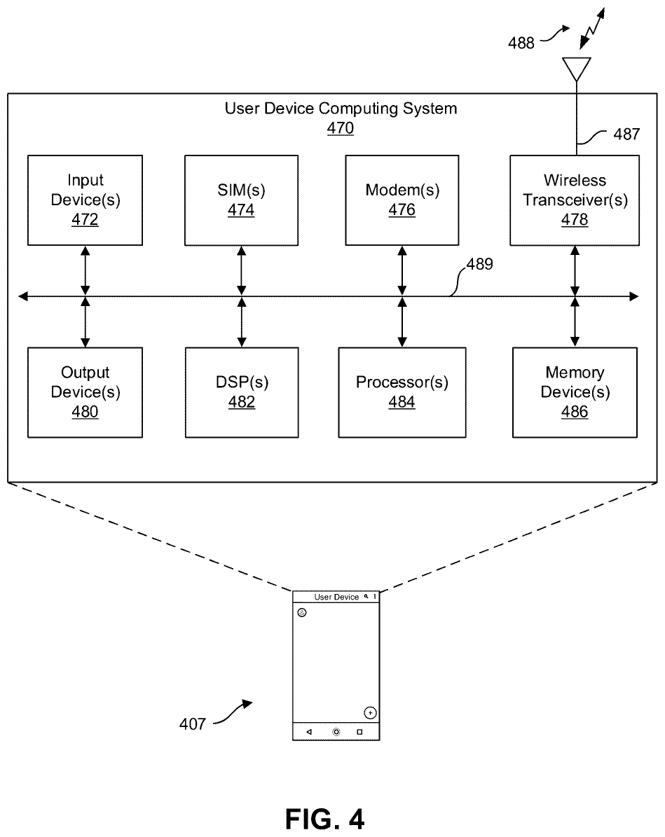

FIG. 4 is a block diagram illustrating components of a user equipment, in accordance with some examples;

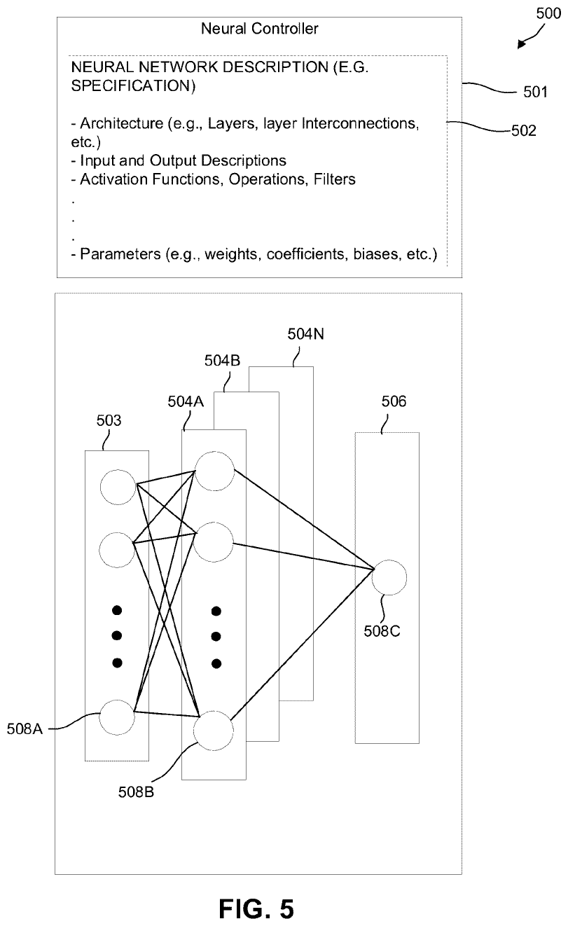

FIG. 5 illustrates an example architecture of a neural network that may be used in accordance with some aspects of the present disclosure;

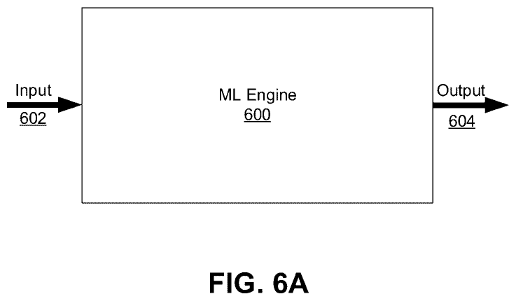

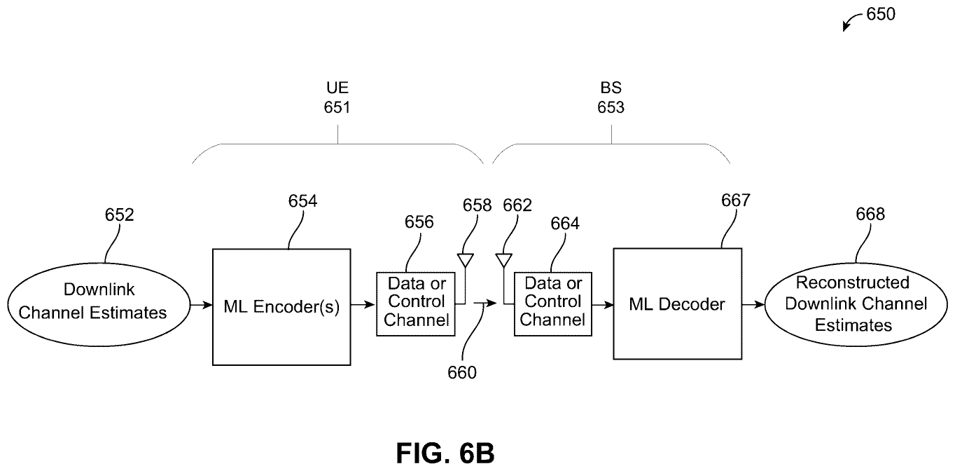

FIG. 6A is a block diagram illustrating an ML engine, in accordance with aspects of the present disclosure;

FIG. 6B is a diagram illustrating an example of a network, in accordance with aspects of the present disclosure;

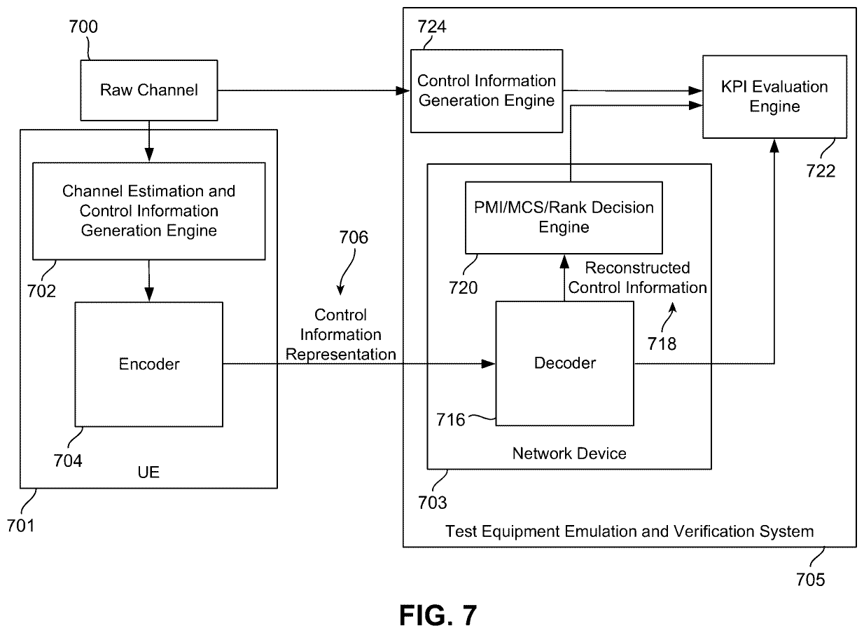

FIG. 7 is a block diagram illustrating an example of a test equipment evaluation and verification system, in accordance with aspects of the present disclosure;

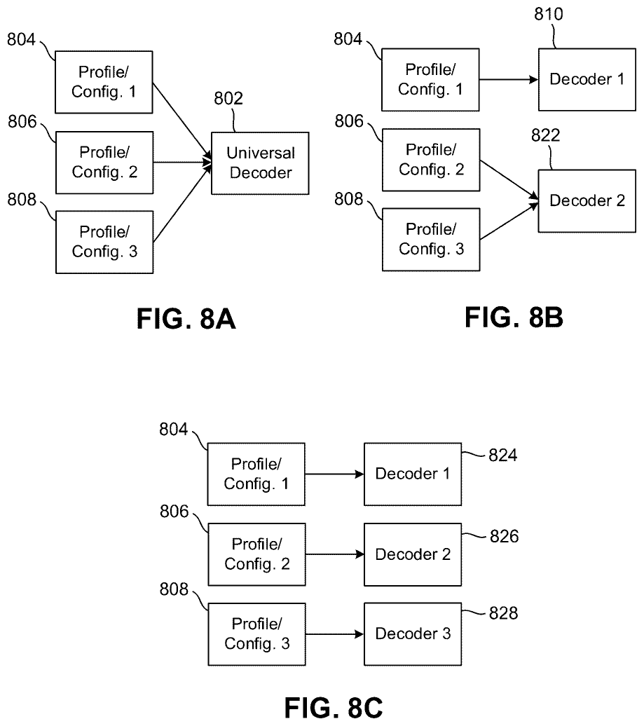

FIG. 8A, FIG. 8B, and FIG. 8C are diagrams illustrating various reference decoder options with respect to different profiles, in accordance with aspects of the present disclosure;

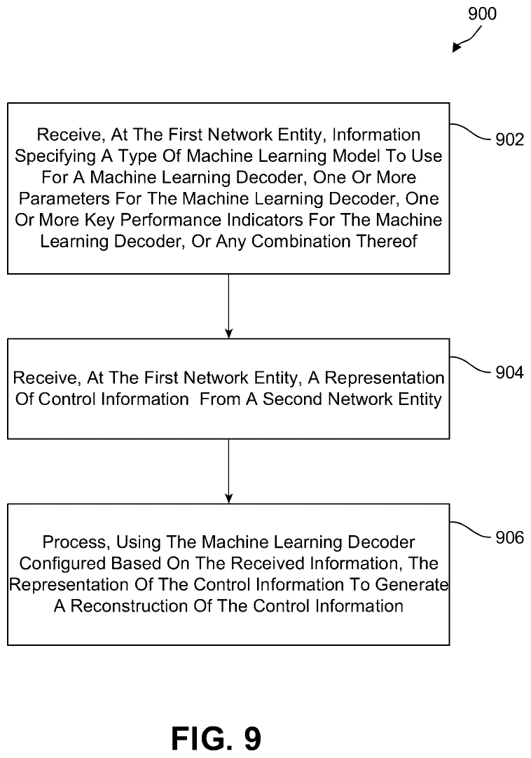

FIG. 9 is a flow diagram illustrating an example of a process for wireless communication, in accordance with aspects of the present disclosure; and

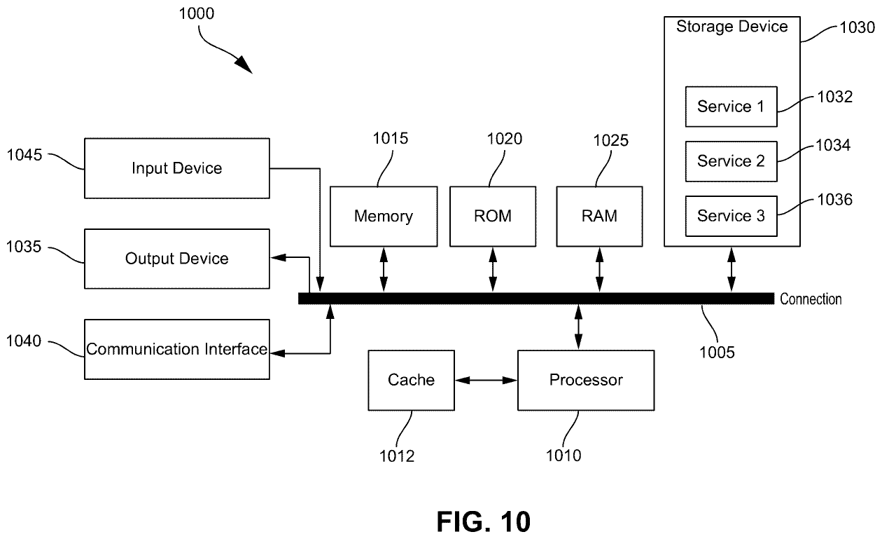

FIG. 10 is a diagram illustrating an example of a system for implementing certain aspects of the present technology.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the application as set forth in the appended claims.

Wireless networks are deployed to provide various communication services, such as voice, video, packet data, messaging, broadcast, and the like. A wireless network may support both access links for communication between wireless devices. An access link may refer to any communication link between a client device (e.g., a user equipment (UE), a station (STA), or other client device) and a base station (e.g., a 3^{rd} Generation Partnership Project (3GPP) gNodeB (gNB) for 5G/NR, a 3GPP eNodeB (eNB) for LTE, a Wi-Fi access point (AP), or other base station) or a component of a disaggregated base station (e.g., a central unit, a distributed unit, and/or a radio unit). In one example, an access link between a UE and a 3GPP gNB may be over a Uu interface. In some cases, an access link may support uplink signaling, downlink signaling, connection procedures, etc.

Various systems and techniques are provided with respect to wireless technologies (e.g., The 3GPP 5G/New Radio (NR) Standard) to provide improvements to wireless communications. A device (e.g., a UE) can be configured to generate or determine control information related to a communication channel upon which the device is communicating or is configured to communicate. For example, a UE can monitor a channel to determine information indicating a quality or state of the channel, which can be referred to as channel state information (CSI) or channel state feedback (CSF). The UE can transmit a report, message, or other signaling including the CSI or CSF to a network device, such as a base station (e.g., a gNB) or a portion of the base station (e.g., a central unit (CU), distributed unit (DU), radio unit (RU), Near-Real Time (Near-RT) radio access network (RAN) Intelligent Controller (RIC), or a Non-Real Time (Non-RT) RIC of a gNB).

In some cases, using a machine learning (ML)-based air interface, a first network device (e.g., a UE) and a second network device (e.g., a gNB) may use trained ML models to implement a function. For instance, a UE that intends to convey CSI to a gNB can use a neural network (e.g., an encoder neural network model) to derive a compressed representation (also referred to as a latent representation) of the CSI for transmission to the gNB. The gNB may use another neural network (e.g., a decoder neural network model) to reconstruct the target CSI from the compressed representation.

In legacy RAN4 CSI reporting tests, test equipment (TE) (e.g., emulating a network device, such as a base station or a portion of the base station) uses CSI reports from UEs for precoding matrix indicator (PMI), modulation and coding scheme (MCS), and rank selection according to the procedures in the RAN1 and RAN4 3GPP specifications. However, when artificial intelligence and machine learning are used to determine control information (e.g., CSI or CSF), a machine learning based decoder (e.g., a decoder neural network model) in the TE can derive implicit or explicit CSI information from the representation (e.g., latent representation) of the CSI reported from the UE. However, such a machine learning based decoder is not explicitly specified in the RAN1 specification.

An output of the machine learning based decoder of the TE can have a significant impact on throughput and/or Block Error Rate (BLER) and thus the pass or failure rate of tests performed by the TE, at least in part based on downlink beamforming being based on the decoder output. The impact of machine learning based decoders on throughput and/or BLER should be considered when defining RAN4 CSI reporting test requirements for such machine learning based decoders. Further, specifications for machine learning based decoders implemented by TE should be included in the RAN4 CSI reporting test definition to ensure the effectiveness of RAN4 CSI reporting test from the perspective of verifying UE performance. Moreover, unlike other RAN4 performance requirements with common receiver algorithm assumptions (e.g., Linear Minimum Mean Square Error (LMMSE)), a UE encoder algorithm/implementation can have large variation across vendors, and the alignment of results across the vendors can be problematic.

Systems, apparatuses, processes (also referred to as methods), and computer-readable media (collectively referred to herein as “systems and techniques”) are described herein for providing a test framework for testing ML-based control information reporting for wireless communication systems. For instance, the systems and techniques can provide a CSI or CSF reporting test framework for ML-based CSI/CSF.

According to some aspects, the systems and techniques can utilize one or more data collection techniques (e.g., RAN4 data collection) for performing validation procedures for one or more reference decoders of test equipment (TE) that are trained to generate reconstructed control information (e.g., reconstructed CSI or CSF). For instance, the systems and techniques can collect data from participating vendors or companies based on agreed test configurations. Each of the vendors or companies can operate respective TE (e.g., emulating a network device, such as a base station or a portion of the base station) including one or more reference decoders. For example, a TE vendor can train a reference decoder to generate reconstructed control information (e.g., reconstructed CSI or CSF) using the collected data based on the reference decoder specifications.

The systems and techniques described herein provide specifications for one or more reference decoders, which can be included in the 3GPP RAN4 Specification for the one or more reference decoders. In one illustrative example (referred to as “Option 1”), the RAN4 Specification can be modified to specify the machine learning model(s) (e.g., neural network model(s)) and the associated parameters (e.g., weights, biases, and/or other parameters) for the reference decoder(s). In some cases, the machine learning model(s) (e.g., the neural network model(s)) and the associated parameters can be determined based on the collected data noted above. For instance, the systems and techniques can determine the neural network model(s) to specify in the RAN4 Specification based on the collected data. In some aspects, the RAN4 Specification can be modified to specify machine learning model(s) (e.g., the neural network model(s)) for reference decoders used for different test configurations. In another illustrative example (referred to as “Option 2”), the RAN4 Specification can be modified to specify the machine learning model(s) (e.g., the neural network model(s)), in some cases for different test configurations, and associated key performance indicator (KPI) criterion(s) with respect to one or a set of specific KPI(s) for the reference decoder(s). In some cases, the machine learning model(s) (e.g., the neural network model(s)) and the KPI criterion(s) can be determined based on the collected data. In another illustrative example (referred to as “Option 3”), the RAN4 Specification can be modified to specify the KPI criterion(s) (e.g., only the KPI criterion(s)) with respect to one or a set of specific KPI(s) for the reference decoder(s). In some cases, the KPI criterion(s) can be determined based on the collected data.

In some aspects, the systems and techniques provide solutions for conducting UE performance verification (e.g., to verify the performance of an ML-based encoder on the UE, such as an encoder neural network model trained to generate a latent or compressed representation of CSI). In one illustrative example, the systems and techniques can perform a PMI test procedure to verify throughput gain of ML-based CSI/CSF based precoding matrix determination as compared to reference precoding matrix determination. In another illustrative example, the systems and techniques can specify (e.g., for the RAN4 Specification) a joint rank indicator (RI)-PMI (RI/PMI) test procedure to verify throughput gain of ML-based CSI/CSF based {rank, precoding} determination versus a reference {rank, precoding} determination.

In one illustrative example, based on the above-noted examples, TE (e.g., emulating a network entity, such as a base station, in one example a gNB, or a portion of the base station) associated with a test equipment vendor can receive information specifying a type of machine learning model to use for a machine learning decoder (e.g., the particular neural network model to use for the decoder neural network model), one or more parameters for the machine learning decoder (e.g., weights and/or biases for the decoder neural network model), one or more KPIs for the machine learning decoder, or any combination thereof. The TE can receive a representation (e.g., a latent or compressed representation) of control information (e.g., CSI or CSF) from a UE or other network entity. For instance, an encoder neural network of the UE can generate a latent (e.g., a compressed) representation of CSI determined by the UE. The TE (e.g., emulating the network device such as a gNB) can then use the machine learning decoder configured based on the received information to process the representation of the control information to generate a reconstruction of the control information. The TE can, in some cases, determine a quality of the reconstruction of the control information based on the one or more KPIs. In some aspects, the TE can determine a performance quality of the UE (or other network entity) based on a comparison of a determined precoding matrix and/or rank a reference precoding matrix and/or a reference rank.

In some cases, a UE encoder machine learning model (e.g., neural network) can be trained by the data provided by TE (e.g., for Option 2 and Option 3 above for the reference decoder). In a first illustrative example of a test type option, the UE machine learning model after training (e.g., under Option 2 and Option 3 above for the reference decoder) can achieve the performance requirement derived from the performance requirement under Option 1 for the reference decoder (e.g., where the model is fully specified by specifying the machine learning model(s), such as the neural network(s), and the associated parameters for the reference decoder). For instance, the fully specified reference decoder (according to Option 1 above for the reference decoder) can be compared to the trained UE machine learning model and can achieve comparable performance. In such an example, the UE can implement the fully specified reference decoder (option 1) to train the UE machine learning encoder model, and therefore it can be considered as a baseline for training the UE machine learning model with the data from the partially specified reference decoder (according to Options 2 and 3 for the reference decoder). In a second illustrative example of a test type option, the UE machine learning model after training (e.g., under Option 2 and Option 3 above for the reference decoder) can exceed the performance of the UE model before training. The trained UE machine learning model can be compared to the UE machine learning model before training, and it can be verified that the UE machine learning model after training performs better than the UE machine learning model before training.

As noted previously, in AI/ML CSI/CSF schemes, UE encoder algorithms/implementations are not specified and there are not common assumptions (e.g., as there are with LMMSE algorithms) that could help achieve results alignment across vendors, such as when defining the RAN4 requirements. Such a lack of alignment in results across vendors can be problematic, such as due to UE encoder algorithms/implementations having large variation across vendors. In some cases, the systems and techniques described herein can provide UE requirement categories, which can provide alignment of results across vendors. For example, the RAN4 specification can be modified to define multiple brackets of KPI ranges and to define one requirement for each KPI range. For instance, a KPI can be evaluated based on a designated reference decoder under the corresponding test conditions and configurations. The KPI range can at least partially ensure encoder/decoder pair performance similarity and throughput enhancement alignment can be improved within a KPI range. In some aspects, the KPI range can be reported as a UE capability or UE assistant information (e.g., assistance data) to the network (e.g., to a base station, such as a gNB, or a portion thereof).

CSI (or CSF) will be used herein as an example of control information. However, the systems and techniques described herein can be used for other types of control information that can be compressed using one or more ML models and decompressed using one or more other ML models.

Additional aspects of the present disclosure are described in more detail below.

As used herein, the terms “user equipment” (UE) and “network entity” are not intended to be specific or otherwise limited to any particular radio access technology (RAT), unless otherwise noted. In general, a UE may be any wireless communication device (e.g., a mobile phone, router, tablet computer, laptop computer, and/or tracking device, etc.), wearable (e.g., smartwatch, smart-glasses, wearable ring, and/or an extended reality (XR) device such as a virtual reality (VR) headset, an augmented reality (AR) headset or glasses, or a mixed reality (MR) headset), vehicle (e.g., automobile, motorcycle, bicycle, etc.), and/or Internet of Things (IoT) device, etc., used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs may communicate with a core network via a RAN, and through the core network the UEs may be connected with external networks such as the Internet and with other UEs. Of course, other mechanisms of connecting to the core network and/or the Internet are also possible for the UEs, such as over wired access networks, wireless local area network (WLAN) networks (e.g., based on IEEE 802.11 communication standards, etc.) and so on.

A network entity may be implemented in an aggregated or monolithic base station architecture, or alternatively, in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. A base station (e.g., with an aggregated/monolithic base station architecture or disaggregated base station architecture) may operate according to one of several RATs in communication with UEs depending on the network in which it is deployed, and may be alternatively referred to as an access point (AP), a network node, a NodeB (NB), an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems, a base station may provide edge node signaling functions while in other systems it may provide additional control and/or network management functions. A communication link through which UEs may send signals to a base station is called an uplink (UL) channel (e.g., a reverse traffic channel, a reverse control channel, an access channel, etc.). A communication link through which the base station may send signals to UEs is called a downlink (DL) or forward link channel (e.g., a paging channel, a control channel, a broadcast channel, or a forward traffic channel, etc.). The term traffic channel (TCH), as used herein, may refer to either an uplink, reverse or downlink, and/or a forward traffic channel.

The term “network entity” or “base station” (e.g., with an aggregated/monolithic base station architecture or disaggregated base station architecture) may refer to a single physical transmit receive point (TRP) or to multiple physical TRPs that may or may not be co-located. For example, where the term “network entity” or “base station” refers to a single physical TRP, the physical TRP may be an antenna of the base station corresponding to a cell (or several cell sectors) of the base station. Where the term “network entity” or “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals (or simply “reference signals”) the UE is measuring. Because a TRP is the point from which a base station transmits and receives wireless signals, as used herein, references to transmission from or reception at a base station are to be understood as referring to a particular TRP of the base station.

In some implementations that support positioning of UEs, a network entity or base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An RF signal comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

Various aspects of the systems and techniques described herein will be discussed below with respect to the figures. According to various aspects, FIG. 1 illustrates an example of a wireless communications system 100. The wireless communications system 100 (which may also be referred to as a wireless wide area network (WWAN)) may include various base stations 102 and various UEs 104. In some aspects, the base stations 102 may also be referred to as “network entities” or “network nodes.” One or more of the base stations 102 may be implemented in an aggregated or monolithic base station architecture. Additionally, or alternatively, one or more of the base stations 102 may be implemented in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. The base stations 102 may include macro cell base stations (high power cellular base stations) and/or small cell base stations (low power cellular base stations). In an aspect, the macro cell base station may include eNBs and/or ng-eNBs where the wireless communications system 100 corresponds to a long term evolution (LTE) network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (which may be part of core network 170 or may be external to core network 170). In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC or 5GC) over backhaul links 134, which may be wired and/or wireless.

The base stations 102 may wirelessly communicate with the UEs 104. Each of the base stations 102 may provide communication coverage for a respective geographic coverage area 110. In an aspect, one or more cells may be supported by a base station 102 in each coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), a virtual cell identifier (VCI), a cell global identifier (CGI)) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency may be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ may have a coverage area 110′ that substantially overlaps with the coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a WLAN AP 150 in communication with WLAN stations (STAs) 152 via communication links 154 in an unlicensed frequency spectrum (e.g., 5 Gigahertz (GHz)). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available. In some examples, the wireless communications system 100 may include devices (e.g., UEs, etc.) that communicate with one or more UEs 104, base stations 102, APs 150, etc. utilizing the ultra-wideband (UWB) spectrum. The UWB spectrum may range from 3.1 to 10.5 GHz.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE and/or 5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. The mmW base station 180 may be implemented in an aggregated or monolithic base station architecture, or alternatively, in a disaggregated base station architecture (e.g., including one or more of a CU, a DU, a RU, a Near-RT RIC, or a Non-RT RIC). Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW and/or near mm W radio frequency band have high path loss and a relatively short range. The mmW base station 180 and the UE 182 may utilize beamforming (transmit and/or receive) over an mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

In some aspects relating to 5G, the frequency spectrum in which wireless network nodes or entities (e.g., base stations 102/180, UEs 104/182) operate is divided into multiple frequency ranges, FR1 (from 450 to 6000 Megahertz. (MHz)), FR2 (from 24250 to 52600 MHz), FR3 (above 52600 MHz), and FR4 (between FR1 and FR2). In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency and/or component carrier over which some base station is communicating, the term “cell,” “serving cell,” “component carrier,” “carrier frequency,” and the like may be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). In carrier aggregation, the base stations 102 and/or the UEs 104 may use spectrum up to Y MHz (e.g., 5, 10, 15, 20, 100 MHz) bandwidth per carrier up to a total of Yx MHz (x component carriers) for transmission in each direction. The component carriers may or may not be adjacent to each other on the frequency spectrum. Allocation of carriers may be asymmetric with respect to the downlink and uplink (e.g., more or less carriers may be allocated for downlink than for uplink). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

In order to operate on multiple carrier frequencies, a base station 102 and/or a UE 104 may be equipped with multiple receivers and/or transmitters. For example, a UE 104 may have two receivers, “Receiver 1” and “Receiver 2,” where “Receiver 1” is a multi-band receiver that may be tuned to band (i.e., carrier frequency) ‘X’ or band ‘Y,’ and “Receiver 2” is a one-band receiver tuneable to band ‘Z’ only. In this example, if the UE 104 is being served in band ‘X,’ band ‘X’ would be referred to as the PCell or the active carrier frequency, and “Receiver 1” would need to tune from band ‘X’ to band ‘Y’ (an SCell) in order to measure band ‘Y’ (and vice versa). In contrast, whether the UE 104 is being served in band ‘X’ or band ‘Y,’ because of the separate “Receiver 2,” the UE 104 may measure band ‘Z’ without interrupting the service on band ‘X’ or band ‘Y.’

The wireless communications system 100 may further include a UE 164 that may communicate with a macro cell base station 102 over a communication link 120 and/or the mm W base station 180 over an mmW communication link 184. For example, the macro cell base station 102 may support a PCell and one or more SCells for the UE 164 and the mmW base station 180 may support one or more SCells for the UE 164.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), Wi-Fi Direct (Wi-Fi-D), Bluetooth®, and so on.

FIG. 2 shows a block diagram of a design of a base station 102 and a UE 104 that enable transmission and processing of signals exchanged between the UE and the base station, in accordance with some aspects of the present disclosure. Design 200 includes components of a base station 102 and a UE 104, which may be one of the base stations 102 and one of the UEs 104 in FIG. 1. Base station 102 may be equipped with T antennas 234a through 234t, and UE 104 may be equipped with R antennas 252a through 252r, where in general T≥1 and R≥1.

At base station 102, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, channel state information, channel state feedback, and/or the like) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. The modulators 232a through 232t are shown as a combined modulator-demodulator (MOD-DEMOD). In some cases, the modulators and demodulators may be separate components. Each modulator of the modulators 232a to 232t may process a respective output symbol stream, e.g., for an orthogonal frequency-division multiplexing (OFDM) scheme and/or the like, to obtain an output sample stream. Each modulator of the modulators 232a to 232t may further process (e.g., convert to analog, amplify, filter, and upconvert) the output sample stream to obtain a downlink signal. T downlink signals may be transmitted from modulators 232a to 232t via T antennas 234a through 234t, respectively. According to certain aspects described in more detail below, the synchronization signals may be generated with location encoding to convey additional information.

At UE 104, antennas 252a through 252r may receive the downlink signals from base station 102 and/or other base stations and may provide received signals to demodulators (DEMODs) 254a through 254r, respectively. The demodulators 254a through 254r are shown as a combined modulator-demodulator (MOD-DEMOD). In some cases, the modulators and demodulators may be separate components. Each demodulator of the demodulators 254a through 254r may condition (e.g., filter, amplify, downconvert, and digitize) a received signal to obtain input samples. Each demodulator of the demodulators 254a through 254r may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 104 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like.

On the uplink, at UE 104, a transmit processor 264 may receive and process data from a data source 262 and control information (e.g., for reports comprising RSRP, RSSI, RSRQ, CQI, channel state information, channel state feedback, and/or the like) from controller/processor 280. Transmit processor 264 may also generate reference symbols for one or more reference signals (e.g., based at least in part on a beta value or a set of beta values associated with the one or more reference signals). The symbols from transmit processor 264 may be precoded by a TX-MIMO processor 266 if application, further processed by modulators 254a through 254r (e.g., for DFT-s-OFDM, CP-OFDM, and/or the like), and transmitted to base station 102. At base station 102, the uplink signals from UE 104 and other UEs may be received by antennas 234a through 234t, processed by demodulators 232a through 232t, detected by a MIMO detector 236 if applicable, and further processed by a receive processor 238 to obtain decoded data and control information sent by UE 104. Receive processor 238 may provide the decoded data to a data sink 239 and the decoded control information to controller (processor) 240. Base station 102 may include communication unit 244 and communicate to a network controller 231 via communication unit 244. Network controller 231 may include communication unit 294, controller/processor 290, and memory 292.

In some aspects, one or more components of UE 104 may be included in a housing. Controller 240 of base station 102, controller/processor 280 of UE 104, and/or any other component(s) of FIG. 2 may perform one or more techniques associated with implicit UCI beta value determination for NR.

Memories 242 and 282 may store data and program codes for the base station 102 and the UE 104, respectively. A scheduler 246 may schedule UEs for data transmission on the downlink, uplink, and/or sidelink.

In some aspects, deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUS), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also may be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which may enable flexibility in network design. The various units of the disaggregated base station, or disaggregated RAN architecture, may be configured for wired or wireless communication with at least one other unit.

FIG. 3 shows a diagram illustrating an example disaggregated base station 300 architecture. The disaggregated base station 300 architecture may include one or more central units (CUs) 310 that may communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more distributed units (DUs) 330 via respective midhaul links, such as an F1 interface. The DUs 330 may communicate with one or more radio units (RUS) 340 via respective fronthaul links. The RUs 340 may communicate with respective UEs 104 via one or more radio frequency (RF) access links. In some implementations, the UE 104 may be simultaneously served by multiple RUs 340.

Each of the units, e.g., the CUS 310, the DUs 330, the RUs 340, as well as the Near-RT RICs 325, the Non-RT RICs 315 and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, may be configured to communicate with one or more of the other units via the transmission medium. For example, the units may include a wired interface configured to receive or transmit signals over a wired transmission medium to one or more of the other units. Additionally, the units may include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions may include radio resource control (RRC), packet data convergence protocol (PDCP), service data adaptation protocol (SDAP), or the like. Each control function may be implemented with an interface configured to communicate signals with other control functions hosted by the CU 310. The CU 310 may be configured to handle user plane functionality (i.e., Central Unit-User Plane (CU-UP)), control plane functionality (i.e., Central Unit-Control Plane (CU-CP)), or a combination thereof. In some implementations, the CU 310 may be logically split into one or more CU-UP units and one or more CU-CP units. The CU-UP unit may communicate bidirectionally with the CU-CP unit via an interface, such as the E1 interface when implemented in an O-RAN configuration. The CU 310 may be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 330 may further host one or more low PHY layers. Each layer (or module) may be implemented with an interface configured to communicate signals with other layers (and modules) hosted by the DU 330, or with the control functions hosted by the CU 310.

Lower-layer functionality may be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 340 may be implemented to handle over the air (OTA) communication with one or more UEs 104. In some implementations, real-time and non-real-time aspects of control and user plane communication with the RU(s) 340 may be controlled by the corresponding DU 330. In some scenarios, this configuration may enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements may include, but are not limited to, CUs 310, DUs 330, RUS 340 and Near-RT RICs 325. In some implementations, the SMO Framework 305 may communicate with a hardware aspect of a 4G RAN, such as an open eNB (O-eNB) 311, via an O1 interface. Additionally, in some implementations, the SMO Framework 305 may communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via 01) or via creation of RAN management policies (such as A1 policies).

FIG. 4 illustrates an example of a computing system 470 of a wireless device 407. The wireless device 407 may include a client device such as a UE (e.g., UE 104, UE 152, UE 190) or other type of device (e.g., a station (STA) configured to communication using a Wi-Fi interface) that may be used by an end-user. For example, the wireless device 407 may include a mobile phone, router, tablet computer, laptop computer, tracking device, wearable device (e.g., a smart watch, glasses, an extended reality (XR) device such as a virtual reality (VR), augmented reality (AR) or mixed reality (MR) device, etc.), Internet of Things (IoT) device, access point, and/or another device that is configured to communicate over a wireless communications network. The computing system 470 includes software and hardware components that may be electrically or communicatively coupled via a bus 489 (or may otherwise be in communication, as appropriate). For example, the computing system 470 includes one or more processors 484. The one or more processors 484 may include one or more CPUs, ASICs, FPGAs, APs, GPUs, VPUs, NSPs, microcontrollers, dedicated hardware, any combination thereof, and/or other processing device or system. The bus 489 may be used by the one or more processors 484 to communicate between cores and/or with the one or more memory devices 486.

The computing system 470 may also include one or more memory devices 486, one or more digital signal processors (DSPs) 482, one or more subscriber identity modules (SIMs) 474, one or more modems 476, one or more wireless transceivers 478, one or more antennas 487, one or more input devices 472 (e.g., a camera, a mouse, a keyboard, a touch sensitive screen, a touch pad, a keypad, a microphone, and/or the like), and one or more output devices 480 (e.g., a display, a speaker, a printer, and/or the like).

In some aspects, computing system 470 may include one or more radio frequency (RF) interfaces configured to transmit and/or receive RF signals. In some examples, an RF interface may include components such as modem(s) 476, wireless transceiver(s) 478, and/or antennas 487. The one or more wireless transceivers 478 may transmit and receive wireless signals (e.g., signal 488) via antenna 487 from one or more other devices, such as other wireless devices, network devices (e.g., base stations such as eNBs and/or gNBs, Wi-Fi access points (APs) such as routers, range extenders or the like, etc.), cloud networks, and/or the like. In some examples, the computing system 470 may include multiple antennas or an antenna array that may facilitate simultaneous transmit and receive functionality. Antenna 487 may be an omnidirectional antenna such that radio frequency (RF) signals may be received from and transmitted in all directions. The wireless signal 488 may be transmitted via a wireless network. The wireless network may be any wireless network, such as a cellular or telecommunications network (e.g., 3G, 4G, 5G, etc.), wireless local area network (e.g., a Wi-Fi network), a Bluetooth™ network, and/or other network.

In some examples, the wireless signal 488 may be transmitted directly to other wireless devices using sidelink communications (e.g., using a PC5 interface, using a DSRC interface, etc.). Wireless transceivers 478 may be configured to transmit RF signals for performing sidelink communications via antenna 487 in accordance with one or more transmit power parameters that may be associated with one or more regulation modes. Wireless transceivers 478 may also be configured to receive sidelink communication signals having different signal parameters from other wireless devices.

In some examples, the one or more wireless transceivers 478 may include an RF front end including one or more components, such as an amplifier, a mixer (also referred to as a signal multiplier) for signal down conversion, a frequency synthesizer (also referred to as an oscillator) that provides signals to the mixer, a baseband filter, an analog-to-digital converter (ADC), one or more power amplifiers, among other components. The RF front-end may generally handle selection and conversion of the wireless signals 488 into a baseband or intermediate frequency and may convert the RF signals to the digital domain.

In some cases, the computing system 470 may include a coding-decoding device (or CODEC) configured to encode and/or decode data transmitted and/or received using the one or more wireless transceivers 478. In some cases, the computing system 470 may include an encryption-decryption device or component configured to encrypt and/or decrypt data (e.g., according to the AES and/or DES standard) transmitted and/or received by the one or more wireless transceivers 478.

The one or more SIMs 474 may each securely store an international mobile subscriber identity (IMSI) number and related key assigned to the user of the wireless device 407. The IMSI and key may be used to identify and authenticate the subscriber when accessing a network provided by a network service provider or operator associated with the one or more SIMs 474. The one or more modems 476 may modulate one or more signals to encode information for transmission using the one or more wireless transceivers 478. The one or more modems 476 may also demodulate signals received by the one or more wireless transceivers 478 in order to decode the transmitted information. In some examples, the one or more modems 476 may include a Wi-Fi modem, a 4G (or LTE) modem, a 5G (or NR) modem, and/or other types of modems. The one or more modems 476 and the one or more wireless transceivers 478 may be used for communicating data for the one or more SIMs 474.

The computing system 470 may also include (and/or be in communication with) one or more non-transitory machine-readable storage media or storage devices (e.g., one or more memory devices 486), which may include, without limitation, local and/or network accessible storage, a disk drive, a drive array, an optical storage device, a solid-state storage device such as a RAM and/or a ROM, which may be programmable, flash-updateable and/or the like. Such storage devices may be configured to implement any appropriate data storage, including without limitation, various file systems, database structures, and/or the like.

In various embodiments, functions may be stored as one or more computer-program products (e.g., instructions or code) in memory device(s) 486 and executed by the one or more processor(s) 484 and/or the one or more DSPs 482. The computing system 470 may also include software elements (e.g., located within the one or more memory devices 486), including, for example, an operating system, device drivers, executable libraries, and/or other code, such as one or more application programs, which may comprise computer programs implementing the functions provided by various embodiments, and/or may be designed to implement methods and/or configure systems, as described herein.

FIG. 5 illustrates an example architecture of a neural network 500 that may be used in accordance with some aspects of the present disclosure. The example architecture of the neural network 500 may be defined by an example neural network description 502 in neural controller 501. The neural network 500 is an example of a machine learning model that can be deployed and implemented at the base station 102, the central unit (CU) 310, the distributed unit (DU) 330, the radio unit (RU) 340, and/or the UE 104. The neural network 500 can be a feedforward neural network or any other known or to-be-developed neural network or machine learning model.

The neural network description 502 can include a full specification of the neural network 500, including the neural architecture shown in FIG. 5. For example, the neural network description 502 can include a description or specification of architecture of the neural network 500 (e.g., the layers, layer interconnections, number of nodes in each layer, etc.); an input and output description which indicates how the input and output are formed or processed; an indication of the activation functions in the neural network, the operations or filters in the neural network, etc.; neural network parameters such as weights, biases, etc.; and so forth.

The neural network 500 can reflect the neural architecture defined in the neural network description 502. The neural network 500 can include any suitable neural or deep learning type of network. In some cases, the neural network 500 can include a feed-forward neural network. In other cases, the neural network 500 can include a recurrent neural network, which can have loops that allow information to be carried across nodes while reading in input. The neural network 500 can include any other suitable neural network or machine learning model. One example includes a convolutional neural network (CNN), which includes an input layer and an output layer, with multiple hidden layers between the input and out layers. The hidden layers of a CNN include a series of hidden layers as described below, such as convolutional, nonlinear, pooling (for downsampling), and fully connected layers. In other examples, the neural network 500 can represent any other neural or deep learning network, such as an autoencoder, a deep belief nets (DBNs), a recurrent neural network (RNN), a generative-adversarial network (GAN), etc.

In the non-limiting example of FIG. 5, the neural network 500 includes an input layer 503, which can receive one or more sets of input data. The input data can be any type of data (e.g., image data, video data, network parameter data, user data, etc.). The neural network 500 can include hidden layers 504A through 504N (collectively “504” hereinafter). The hidden layers 504 can include n number of hidden layers, where n is an integer greater than or equal to one. The n number of hidden layers can include as many layers as needed for a desired processing outcome and/or rendering intent. In one illustrative example, any one of the hidden layers 504 can include data representing one or more of the data provided at the input layer 503. The neural network 500 further includes an output layer 506 that provides an output resulting from the processing performed by hidden layers 504. The output layer 506 can provide output data based on the input data.

In the example of FIG. 5, the neural network 500 is a multi-layer neural network of interconnected nodes. Each node can represent a piece of information. Information associated with the nodes is shared among the different layers and each layer retains information as information is processed. Information can be exchanged between the nodes through node-to-node interconnections between the various layers. The nodes of the input layer 503 can activate a set of nodes in the first hidden layer 504A. For example, as shown, each input node of the input layer 503 is connected to each node of the first hidden layer 504A. The nodes of the hidden layer 504A can transform the information of each input node by applying activation functions to the information. The information derived from the transformation can then be passed to and can activate the nodes of the next hidden layer (e.g., 504B), which can perform their own designated functions. Example functions include convolutional, up-sampling, data transformation, pooling, and/or any other suitable functions. The output of hidden layer (e.g., 504B) can then activate nodes of the next hidden layer (e.g., 504N), and so on. The output of last hidden layer can activate one or more nodes of the output layer 506, at which point an output can be provided. In some cases, while nodes (e.g., nodes 508A, 508B, 508C) in the neural network 500 are shown as having multiple output lines, a node can have a single output and all lines shown as being output from a node can represent the same output value.

In some cases, each node or interconnection between nodes can have a weight that is a set of parameters derived from training the neural network 500. For example, an interconnection between nodes can represent a piece of information learned about the interconnected nodes. The interconnection can have a numeric weight that can be tuned (e.g., based on a training data set), allowing the neural network 500 to be adaptive to inputs and able to learn as more data is processed.

The neural network 500 can be pre-trained to process the features from the data in the input layer 503 using different hidden layers 504 in order to provide the output through the output layer 506. For example, in some cases, the neural network 500 can adjust weights of nodes using a training process called backpropagation. Backpropagation can include a forward pass, a loss function, a backward pass, and a weight update. The forward pass, loss function, backward pass, and parameter update can be performed for one training iteration. The process can be repeated for a certain number of iterations for each set of training data until the weights of the layers are accurately tuned (e.g., meet a configurable threshold determined based on experiments and/or empirical studies).

Increasingly ML (e.g., AI) algorithms (e.g., models) are being incorporated into a variety of technologies including wireless telecommunications standards. FIG. 6A is a block diagram illustrating an ML engine 600, in accordance with aspects of the present disclosure. As an example, one or more devices in a wireless system may include the ML engine 600. In some cases, ML engine 600 may be similar to neural network 500. In this example, ML engine 600 includes three parts, input 602 to the ML engine 600, the ML engine, and the output 604 from the ML engine 600. The input 602 to the ML engine 600 may be data from which the ML engine 600 may use to make predictions or otherwise operate on. As an example, an ML engine 600 configured to select an RF beam may take, as input 602, data regarding current RF conditions, location information, network load, etc. As another example, data related to packets sent to a UE, along with historical packet data may be input 602 to an ML engine 600 configured to predict a discontinuous reception (DRX) schedule for the UE. In some cases, the output 604 may be predictions or other information generated by the ML engine 600 and the output 604 may be used to configure a wireless device, adjust settings, parameters, modes of operations, etc. Continuing the previous examples, the ML engine 600 configured to select an RF beam may output 604 a RF beam or set of RF beams that may be used. Similarly, the ML engine 600 configured to predict a DRX schedule for the UE may output a DRX schedule for the UE.

In another example, the ML engine 600 may be an encoder used to compress control information (e.g., channel state information (CSI) or channel state feedback (CSF)) determined by a UE in order to generate a representation (e.g., a latent representation) of the control information. In another example, the ML engine 600 may be an encoder used by a network entity (e.g., a base station) to decode a representation (e.g., a latent representation) of the control information (e.g., CSI) generated by a UE.

FIG. 6B is a diagram illustrating an example of a network 650 including a UE 651 and a base station 653 (e.g., a gNB or a portion of a gNB, such as a CU, DU, RU, etc. of a gNB having a disaggregated architecture). As shown in FIG. 6B, downlink channel estimates 652 (e.g., CSI or CSF) are provided to an encoder 654 of the UE 651. The CSI encoder 654 encodes the CSI and the UE 651 transmits the encoded CSI (e.g., a latent representation of the CSI, such as a feature vector representing the CSI) using antenna 658 via a data or control channel 656 over a wireless or air interface 660 to a receiving antenna 662 of the base station 653. In some cases, the UE 651 can transmit a latent message representing the CSI.

The encoded CSI is provided via a data or control channel 664 to a CSI decoder 667 of the base station 653 that can decode the encoded CSI to generate a reconstructed downlink channel estimate 668 (or reconstructed CSI). In some cases, the base station 653 can then determine a precoding matrix, a modulation and coding scheme (MCS), and/or a rank associated with one or more antennas of the base station. Based on the precoding matrix, the MCS, and/or the rank, the base station 653 can determine a configuration of control resources (e.g., via a physical downlink control channel (PDCCH)) or data resources (e.g., via a physical downlink shared channel (PDSCH)).

As noted previously, a machine learning based decoder is not explicitly specified in the RAN1 specification. Furthermore, the RAN4 defines CSI reporting test requirements for test equipment (TE), but not for ML based decoders. An output of an ML decoder of a TE can have a significant impact on throughput and/or Block Error Rate (BLER), and can affect the pass or failure rate of tests performed by the TE based, at least in part, on downlink beamforming being based on the decoder output. The impact of ML based decoders on throughput and/or BLER should be a consideration when defining RAN4 CSI reporting test requirements for such ML based decoders. Moreover, specifications for machine learning based decoders implemented by TE should be included in the RAN4 CSI reporting test definition to ensure the effectiveness of RAN4 CSI reporting test from the perspective of verifying UE performance.

As also previously noted, systems and techniques are described herein for providing a test framework for testing ML-based control information reporting for wireless communication systems that include ML based decoders. Illustrative examples will be described herein with respect to the systems and techniques providing a CSI or CSF reporting test framework for ML-based CSI/CSF. However, the systems and techniques can apply to other types of control information other than CSI.

FIG. 7 is a diagram illustrating an example of a system including a UE 701 and a test equipment emulation and verification system 705. The test equipment emulation and verification system 705 is implemented using a network device 703 (e.g., a base station, such as a gNB, or a portion thereof, such as a CU, RU, DU, etc. of the base station). Similar to the system of FIG. 6B, a channel estimation and control information generation engine 702 of the UE 701 can measure communications on a raw channel 700 (e.g., downlink reference signals from the network device 703) and generate control information, such as CSI. An encoder 704 of the UE 701 can encode the CSI and transmit a representation 706 of the control information (e.g., a latent representation of the CSI, such as a feature vector representing the CSI) over a wireless or air interface to the network device 703. A decoder 716 of the network device 703 can decode the representation 706 of the control information to generate a reconstruction 718 of the control information (e.g., a reconstruction of the CSI). A PMI/MCS/rank decision engine 720 can then determine a precoding matrix, a modulation and coding scheme (MCS), and/or a rank associated with one or more antennas of the base station.

In some cases, the test equipment emulation and verification system can utilize one or more data collection techniques (e.g., RAN4 data collection) for performing validation procedures for one or more reference decoders of test equipment (e.g., the decoder 716 of the network device 703) trained to generate reconstructed CSI (or CSF). For instance, the test equipment emulation and verification system 705 can collect data from participating vendors or companies based on agreed test configurations. The test equipment emulation and verification system 705 be associated with (e.g., owned by) a particular test equipment vendor. Multiple test equipment vendors can each have respective test equipment emulation and verification systems similar to that shown in FIG. 7. Each of the vendors or companies can operate the respective test equipment emulation and verification systems, which can each include one or more reference decoders. For example, the vendor associated with the test equipment emulation and verification system 705 can train the reference decoder 716 of FIG. 7 to generate reconstructed CSI or CSF using the collected data based on the reference decoder specifications. Any suitable training technique can be used to train the reference decoder 716.

In some cases, a set of profiles can be defined to generate channel realization. In some cases, the set of profiles (e.g., configuration profiles) can be specified in RAN4. For example, the set of profiles can define a test setup to generate the channel that will be fed into UE 701 for determining the CSI (by the channel estimation and control information generation engine 702), generating the encoded CSI (by the encoder 704), and generating the reconstructed CSI (by the decoder 716). In some cases, the set of profiles can include one or more {propagation channel, gNB/UE antenna configuration, device type} profiles (e.g., specified in RAN4), where the propagation channel condition, gNB and/or UE antenna configuration(s), and device type can be important parameters for the test setup. As noted above, the use of brackets “{ }” indicates that any combination of elements in the brackets can be used to form a configuration or a profile. Illustrative examples of the propagation channel conditions can include specified Doppler spread, specified delay spread, a specified channel multi-path profile, any combination thereof, and/or other propagation channel conditions for the test setup. The gNB and/or UE antenna configuration conditions can specify how many antenna elements for the network device 703 and/or the UE 701. how the antenna elements are to be arranged (e.g., how many antenna elements in a first dimension and how many antenna elements in a second dimension), a specified antenna element gain, any combination thereof, and/or other antenna conditions for the test setup. The gNB and the UE can have separate antenna configurations in some cases. Examples of device types include unlicensed, customer premise equipment (CPE), and/or other device types.

Each vendor or company participating in reference decoder development can provide training and test data set, which can include {ground truth corresponding to the decoder output, encoder output}, based on its own encoder implementation. Test equipment vendors can train their decoder(s) (e.g., the decoder 716) based on mixed training data sets provided by multiple vendors or companies based on a selected loss function (e.g., L1 loss).

The systems and techniques described herein provide specifications for one or more reference decoders, which can be included in the 3GPP RAN4 Specification for the one or more reference decoders. For instance, according to some aspects, the RAN4 Specification can be modified to specify the neural network model(s) and the associated parameters (e.g., weights, biases, and/or other parameters) for the reference decoder(s), referred to as Option 1 as noted previously. For example, the test equipment emulation and verification system 705 of FIG. 7 can receive information specifying the neural network model and parameters to use for the decoder 716. In some cases, the neural network model(s) and the associated parameters can be determined based on the collected data noted above. For instance, the systems and techniques can determine the neural network model(s) to specify in the RAN4 Specification based on the collected data. In some aspects, the RAN4 Specification can be modified to specify neural network models for reference decoders used for different test configurations.

In some aspects, the RAN4 Specification can be modified to specify the neural network model(s) (in some cases for different test configurations) and associated key performance indicator (KPI) criterion(s) with respect to one or a set of specific KPI(s) for the reference decoder(s), referred to as Option 2 as noted previously. In some cases, the neural network model(s) and the KPI criterion(s) can be determined based on the collected data. In other aspects, the RAN4 Specification can be modified to specify the KPI criterion(s) (e.g., only the KPI criterion(s) and not the particular neural network model(s)) with respect to one or a set of specific KPI(s) for the reference decoder(s), referred to as Option 3 as noted previously. In some cases, the KPI criterion(s) can be determined based on the collected data. In such aspects, the parameters of the model may not be specified, in which case vendors can train their own decoder models with different parameters, as long as they meet the KPI criterion(s).

In some cases, a validation entity (e.g., of the test equipment emulation and verification system 705 or other entity) can validate a trained decoder model (e.g., the decoder 716) by using mixed test data set provided by multiple vendors or companies. For instance, the validation entity can require that a reference decoder satisfies the KPI criterion(s) with respect to specified KPI(s) when tested with mixed test data set in the event the KPI criterion(s) are included as part of the reference decoder specification for RAN4. In some cases, the test data set is not disclosed to the test equipment vendors.

In some aspects, a KPI can be a function defined to evaluate the accuracy of a decoder recovered message (e.g., a decoder output, such as the reconstruction 718 of CSI output by the decoder 716), given the decoder input (e.g., a latent representation of the CSI transmitted by the UE 701), with respect to the ground truth corresponding to the decoder output (e.g., the ground truth CSI corresponding to the reconstruction of the CSI). In one illustrative example, a KPI can be defined as KPI=f(g(mₗₐₜₑₙₜ),mᵢₙₚᵤₜ), where f( ) is a function (e.g., a squared generalized cosine similarity function), g(mₗₐₜₑₙₜ) is the decoder output, mₗₐₜₑₙₜ is the latent message transmitted by UE (e.g., the latent representation of the CSI generated by the encoder 704 of the UE 701), and mᵢₙₚᵤₜ is the ground truth corresponding to the decoder output (e.g., the ground truth CSI corresponding to the reconstruction of the CSI).

In one illustrative example, referring to FIG. 7, the test equipment emulation and verification system 705 can receive information specifying the neural network model and the KPIs to use for the decoder 716. Using a set of test data (from the collected data noted above), the channel estimation and control information generation engine 702 of the UE 710 can generate a set of CSI (referred to as ground truth CSI) and the encoder 704 can generate encoded CSI. In some cases, the control information generation engine 724 can generate the ground truth CSI. The UE 701 can transmit a representation (e.g., a latent representation) of the CSI to the network device 703. The decoder 716 of the network device 703 can decode the representation of the CSI to generate the reconstruction 718 of the CSI. Using the specified KPI criterion(s), a KPI evaluation engine 722 of the test equipment emulation and verification system 705 can evaluate the similarity between the reconstruction 718 of the CSI output by the decoder 716 and the ground truth CSI generated by the channel estimation and control information generation engine 702 of the UE 710.

In some cases, when specifying the decoder neural network structure(s), the RAN4 specification can be modified to include various options to specify one or more reference decoders for one or multiple profiles (e.g., configuration profiles), such as one or more {propagation channel, gNB/UE antenna configuration, device type} profiles as described above. FIG. 8A, FIG. 8B, and FIG. 8C are diagrams illustrating various reference decoder options with respect to different profiles. According to a first option, RAN4 can specify a universal reference decoder for all profiles (e.g., all {propagation channel, gNB/UE antenna configuration, device type} profiles). For example, as shown in FIG. 8A, a universal decoder 802 can be specified for a first profile or configuration 804, a second profile or configuration 806, and a third profile or configuration 808. According to a second option, RAN4 can specify a common reference decoder for multiple propagation channel profiles for each of {gNB/UE antenna configuration, device type} profiles. For example, as shown in FIG. 8B, a first decoder 810 can be specified for the first profile or configuration 804, and a second decoder 822 can be specified for the second profile or configuration 806 and the third profile or configuration 808. According to a third option, RAN4 can specify separate reference decoders for each of the profiles (e.g., each of the {propagation channel, gNB/UE antenna configuration, device type} profiles). For example, as shown in FIG. 8C, a first decoder 824 can be specified for the first profile or configuration 804, a second decoder 826 can be specified for the second profile or configuration 806, and a third decoder 828 can be specified for the third profile or configuration 808. In some aspects, RAN4 can be modified to define selection mechanisms for the second option and/or the third option.

In some aspects, the systems and techniques provide solutions for conducting UE performance verification (e.g., to verify the performance of an ML-based encoder on the UE, such as an encoder neural network model trained to generate a latent or compressed representation of CSI). For example, in some cases, a UE ML-based encoder (e.g., neural network) can be trained by the data provided by a TE, such as a reference decoder of the TE (e.g., for Option 2 and Option 3 above for the reference decoder). In a first illustrative example of a test type option, the UE ML-based encoder after training (e.g., under Option 2 and Option 3 above for the reference decoder) can achieve the performance requirement derived from the performance requirement for the reference decoder under Option 1 (e.g., where the model is fully specified by specifying the machine learning model(s), such as the neural network(s), and the associated parameters for the reference decoder). For instance, the fully specified ML-based reference decoder (according to Option 1) can be compared to the trained UE ML-based encoder and can achieve comparable performance. In such an example, the UE can implement the fully specified ML-based reference decoder (according to Option 1) to train the UE ML-based encoder. The fully specified ML-based reference decoder can be considered as a baseline for training the UE ML-based encoder with the data from a partially specified ML-based reference decoder (according to Options 2 and 3 for the reference decoder). In a second illustrative example of a test type option, the UE ML-based encoder after training (e.g., under Option 2 and Option 3 above for the reference decoder) can exceed the performance of the UE ML-based encoder before training. The trained UE ML-based encoder can be compared to the UE ML-based encoder before training, and it can be verified that the UE ML-based encoder after training performs better than the UE ML-based encoder before training.

One or more reporting type test option can be used for UE performance verification. For example, in some cases, a device or system (e.g., the test equipment emulation and verification system 705) can perform a precoding matrix indicator (PMI) test procedure to verify throughput gain of a precoding matrix determined using a reconstruction of CSI (e.g., the output CSI reconstruction 718 from the decoder 716) as compared to a reference precoding matrix determination. In one example, the reference precoding matrix is a random precoding. In another example, the reference precoding matrix is a precoding based on Release-15 type 1 CSI feedback. In some cases, rank and MCS are fixed in the test. In other cases, rank and MCS can also be tested.

For instance, to perform the PMI test procedure, the gNB 705 can determine a precoding matrix based on a PMI received from the UE 701. The PMI can be determined by the UE 701 using traditional CSI determination techniques, such as based on measurements of the quality of downlink signals received from the network device 703. The network device 703 can determine the reference precoding matrix based on the received PMI. The UE 701 can also use the encoder 704 to generate a representation of CSI (e.g., a latent representation of the CSI) and can transmit the representation 706 of the CSI/CSF to the network device 703. The decoder 716 can then decode the representation 706 of the CSI to generate the reconstruction 718 of the CSI. The network device 703 can then determine a second precoding matrix (referred to as the ML-based CSI based precoding matrix) using the reconstruction 718 of the CSI. The test equipment and verification system 705 can compare throughput gains obtained using the reference precoding matrix to throughput gains obtained using the ML-based CSI/CSF based precoding matrix to verify that the performance of the encoder neural network model of the UE meets minimum performance requirements (e.g., defined by the RAN4 Specification).

In another illustrative example, the systems and techniques can specify (e.g., for the RAN4 Specification) a joint rank indicator (RI)-PMI (RI/PMI) test procedure to verify throughput gain of ML-CSI based {rank, precoding} determination versus a reference {rank, precoding} determination. In some cases, the reference {rank, precoding} is {fixed rank 1, random precoding}. In other cases, the reference {rank, precoding} is {rank, precoding} based on Release-15 type 1 CSI feedback. In some cases, the MCS is fixed in this type of test.

In some cases, the systems and techniques described herein can provide UE requirement categories, which can provide alignment of results across vendors, such as when defining the RAN4 requirements. For instance, using throughput as an illustrative example of a performance metric, it may be desired to determine or compare how much throughput improvement an ML-based CSI/CSF scheme achieves relative to a legacy CSI/CSF scheme (e.g., a non-ML-based CSI/CSF scheme). Simulation data may be received from different companies, for example, company A may report an 8% throughput improvement using a first ML-based CSI-CSF scheme (e.g., using an ML-based encoder at a UE and a corresponding ML-based decoder at a gNB or TE), company B may report a 10% throughput improvement using a second ML-based CSI-CSF scheme, and company C may report a 12% throughput improvement using a third ML-based CSI-CSF scheme. A predetermined throughput improvement value or range threshold (over the legacy CSI/CSF scheme) can be determined by taking an average of the various throughput improvements reported by the various companies. Using the example from above, a predetermined throughput improvement value can be determined as 10%, which is the average throughput improvement based on the 8%, 10%, and 12% throughput improvements reported by company A, B, and C, respectively. The throughput improvement value can be used as a minimum throughput improvement that must be achieved by a given ML-based encoder for a particular UE. For instance, in such an example, for a given ML-based encoder to meet RAN4 requirements, the ML-based encoder needs to provide at least a 10% improvement over legacy CSI/CSF schemes.

However, UE ML-based encoder algorithms/implementations are not specified and there are no common assumptions for such UE ML-based encoder algorithms/implementations that can help achieve alignment in results across vendors when the defining RAN4 requirement (e.g., the throughput improvement value described above). For example, with the possibility of such a wide variety of ML-based encoders, a wide range of improvement results (e.g., throughput improvements) may be reported by the various companies implementing the ML-based encoders. For example, throughput improvement results from various companies may be in a range of 5% to 20%. The difference in the improvement results can be due to various factors, such as a size, complexity, etc. of the various ML-based encoder models (e.g., a size and/or number of parameters of each respective neural network-based encoder, the type of training technique used to train the ML-based encoder models, the type of ML model, etc.). With such a large range of improvement results, it may not make sense to take an average of the full range of results, as such a solution may result in a large number of the ML-based encoders failing to provide improvement results that are greater than a pre-determined improvement value (e.g., a throughput improvement value).

To address such an issue, the systems and techniques described herein can define multiple brackets of KPI ranges and can define at least one requirement (e.g., a throughput enhancement requirement, such as a throughput improvement value, and/or other metric) for each KPI range. Such KPI ranges and requirements can be included in the RAN4 Specification. One illustrative example is provided in Table 1 below:

TABLE 1

| | Throughput Enhancement |
|---|---|
| | Requirement (relative to legacy |
| KPI Range | CSF) |
| KPI > x0 | Y1 |
| x1 < KPI < x0 | Y2 |
| KPI < x1 | Y3 |

KPI can be used as the range since it is based on the decoder output and is thus an intermediate result that is related to or correlated with the performance of the ML-based encoder at the UE which, as noted above, can be based on a size, complexity, etc. of the ML-based encoder model. For instance, as previously described, the KPI is a function defined to evaluate the accuracy of reconstructed or recovered output (e.g., the reconstructed CSI or CSF) of the ML-based decoder. Accordingly, if the ML-based encoder and ML-based decoder operate so that the ML-based decoder is able to reconstruct the output with high accuracy (e.g., so that the reconstructed CSI/CSF closely matches the CSI/CSF information that was encoded by the ML-based encoder), then the result will be good improvement in the throughput relative to the legacy CSI/CSF technique.

Because KPI is directly related to the performance of the ML-based encoder, the KPI ranges can be defined based on the variance of the ML-based encoders that can be used by different companies or vendors (which, as noted above, result in a wide range of improvement results, such as throughput improvements, being reported by the various companies implementing the ML-based encoders). For instance, using the example above where throughput improvement results from various companies are in a range of 5% to 20%, the first KPI range (KPI>x0) in Table 1 above can be defined for a high end of the range (e.g., a first sub-range of 16% to 20%), the second KPI range (x1<KPI<x0) in Table 1 above can be defined for a middle of the range (e.g., a second sub-range of 10% to 15%), and the third KPI range (KPI<x1) in Table 1 above can be defined for a low end of the range (e.g., a third sub-range of 5% to 9%). The x1 term can represent the lowest KPI of the ML-based encoders used in the calculation, and the x0 term can represent the highest KPI of the ML-based encoders used in the calculation.

The respective throughput enhancement requirement (Y1, Y2, and Y3) for each KPI range can be determined as a representative value (e.g., an average) of the values in the respective sub-range if throughput improvement results. In one illustrative example, the first sub-range of throughput improvement results for the first KPI range (KPI>x0) may include values of 16%, 18%, and 20%, in which case the throughput enhancement requirement Y1 (or throughput improvement value) for the first KPI range can be determined as 18% (an average of 16%, 18%, and 20%). In another illustrative example, the second sub-range of throughput improvement results for the second KPI range (x1<KPI<x0) may include values of 10%, 11%, and 15%, in which case the throughput enhancement requirement Y2 for the second KPI range can be determined as 12% (an average of 10%, 11%, and 15%). In another illustrative example, the third sub-range of throughput improvement results for the third KPI range (KPI<x1) may include values of 5%, 7%, and 9%, in which case the throughput enhancement requirement Y3 for the third KPI range can be determined as 7% (an average of 5%, 7%, and 9%).

In some cases, the KPI can be evaluated based on a designated reference decoder under the corresponding test conditions and configurations. The KPI range can at least partially ensure encoder/decoder pair performance similarity (e.g., based on the similarities in KPIs in the given KPI ranges) and throughput enhancement alignment can be improved within a KPI range.

In some aspects, the KPI range can be reported as a UE capability or UE assistant information (e.g., assistance data) to the network (e.g., to a base station, such as a gNB, or a portion thereof). For instance, a network device can receive a KPI range associated with a UE, and can use the KPI range to determine the improvement it can expect with respect to a particular metric, such as throughput, for the UE when it is configuring the machine learning-based control information (e.g., CSI/CSF) reporting. In one example, the network device may only enable machine learning-based control information (e.g., CSI/CSF) reporting if the throughput (or other metric) is enhanced by a certain amount (e.g., greater than a throughput enhancement requirement) when an ML-based CSI/CSF encoder and decoder pair are used.

FIG. 9 is a flow diagram illustrating a process 900 for performing wireless communications. The process 900 can be performed by a first network entity associated with a test equipment vendor or by a component or system (e.g., a chipset) of the first network entity. The first network entity can be or can be part of a test equipment (TE) emulating a base station (e.g., the network device 703 of FIG. 7), such as a test equipment emulation and verification system (e.g., the test equipment emulation and verification system 705 of FIG. 7). The operations of the process 900 may be implemented as software components that are executed and run on one or more processors (e.g., processor 1010 of FIG. 10 or other processor(s)). Further, the transmission and reception of signals by the first network entity in the process 900 may be enabled, for example, by one or more antennas and/or one or more transceivers (e.g., wireless transceiver(s)).

At block 902, the first network entity (or component thereof) can receive information specifying a type of machine learning model to use for a machine learning decoder, one or more parameters for the machine learning decoder, one or more key performance indicators for the machine learning decoder, or any combination thereof. As described herein, the machine learning decoder can include a neural network architecture. In one example, the information specifies the type of machine learning model to use for the machine learning decoder. In some cases, in addition to the type of machine learning model to use for the machine learning decoder, the information further specifies the one or more parameters (e.g., weights, biases, etc.) for the machine learning decoder. In another example, the information specifies the type of machine learning model to use for the machine learning decoder and the one or more key performance indicators for the machine learning decoder (e.g., and not parameters for the machine learning decoder). In another example, the information specifies the one or more key performance indicators for the machine learning decoder (e.g., and not the type of neural network or the parameters for the machine learning decoder).

At block 904, the first network entity (or component thereof) can receive a representation of control information (e.g., the control information representation 706 of FIG. 7) from a second network entity. For instance, the second network entity can be or can be a part of a user equipment (UE) (e.g., the UE 701 of FIG. 1). In one illustrative example, the control information includes channel state information (CSI) or channel state feedback (CSF). In some cases, the representation of the control information is a latent representation of the control information. In one example, the latent representation of the control information includes a feature vector representing the control information. In some aspects, the latent representation of the control information is received from a machine learning encoder of the second network entity (e.g., the encoder 704 of the UE 701 of FIG. 7). In some cases, a machine learning encoder of the second network entity is trained using data generated based on the machine learning decoder of the first network entity.

At block 906, the first network entity (or component thereof) can process, using the machine learning decoder configured based on the received information, the representation of the control information to generate a reconstruction of the control information (e.g., the reconstructed control information 718 of FIG. 7). In some aspects, the first network entity (or component thereof) can determine, based on the reconstruction of the control information, at least one of a precoding matrix or a rank of one or more antennas of the first network entity. In some cases, the first network entity (or component thereof) can configure the machine learning decoder based on the information. In some aspects, the first network entity (or component thereof) can determine a quality of the reconstruction of the control information based on the one or more key performance indicators.

In some aspects, the first network entity (or component thereof) can determine a performance quality of the second network entity based on a comparison of least one of the precoding matrix or the rank to at least one of a reference precoding matrix or a reference rank. In some cases, the performance quality is based on a throughput gain.

In some aspects, the first network entity (or component thereof) can train the machine learning decoder using data based on a set of profiles specified for the data. In some cases, the data is comprised of multiple sets of data from a plurality of vendors, with each set of data of the multiple sets of data being provided by a respective vendor of the plurality of vendors. The set of profiles for the data can include one or more parameters associated with at least one of a propagation channel condition, an antenna configuration for the first network entity, or a device type (e.g., the {propagation channel, gNB/UE antenna configuration, device type} profiles described herein). In one illustrative example, the received information specifies a single type of machine learning model to use for the machine learning decoder for all profiles in the set of profiles (e.g., as shown in FIG. 8A). In another illustrative example, the received information specifies a first type of machine learning model to use for the machine learning decoder for at least a first profile in the set of profiles and a second type of machine learning model to use for the machine learning decoder for at least a second profile in the set of profiles (e.g., as shown in FIG. 8B). In another illustrative example, the information specifies a separate type of machine learning model to use for the machine learning decoder for each profile in the set of profiles (e.g., as shown in FIG. 8C).

In some cases, the first network entity (or component thereof) can receive a key performance indicator (KPI) range associated with a second network entity, such as one of the KPI ranges shown in Table 1 above. As described above, the KPI range can be associated with a throughput enhancement requirement (e.g., Y1, Y2, or Y3 of Table 1. For instance, a UE can report to the network entity (e.g., a base station, such as a gNB, or a portion of the base station) the KPI range as a UE capability or UE assistant information (e.g., assistance data). The network device can use the received KPI range to determine the throughput improvement (or other metric improvement) it can expect for the UE when it is configuring the machine learning-based control information (e.g., CSI/CSF) reporting. In one example, the network device may only enable machine learning-based control information (e.g., CSI/CSF) reporting if the throughput (or other metric) is enhanced by a certain amount (e.g., greater than a throughput enhancement requirement) when an ML-based CSI/CSF encoder and decoder pair are used.

In some examples, the processes described herein (e.g., process 900 and/or other process described herein) may be performed by a computing device or apparatus (e.g., a UE or a base station). For example, the process 900 may be performed by the test equipment emulation and verification system 705 of FIG. 5. In another example, the process 900 may be performed by the system 1000 of FIG. 10 configured to implement the test equipment emulation and verification system 705 of FIG. 5.

FIG. 10 is a diagram illustrating an example of a system for implementing certain aspects of the present technology. In particular, FIG. 10 illustrates an example of computing system 1000, which may be for example any computing device making up internal computing system, a remote computing system, a camera, or any component thereof in which the components of the system are in communication with each other using connection 1005. Connection 1005 may be a physical connection using a bus, or a direct connection into processor 1010, such as in a chipset architecture. Connection 1005 may also be a virtual connection, networked connection, or logical connection.

In some embodiments, computing system 1000 is a distributed system in which the functions described in this disclosure may be distributed within a datacenter, multiple data centers, a peer network, etc. In some embodiments, one or more of the described system components represents many such components each performing some or all of the function for which the component is described. In some embodiments, the components may be physical or virtual devices.

Example system 1000 includes at least one processing unit (CPU or processor) 1010 and connection 1005 that communicatively couples various system components including system memory 1015, such as read-only memory (ROM) 1020 and random access memory (RAM) 1025 to processor 1010. Computing system 1000 may include a cache 1012 of high-speed memory connected directly with, in close proximity to, or integrated as part of processor 1010.

Processor 1010 may include any general purpose processor and a hardware service or software service, such as services 1032, 1034, and 1036 stored in storage device 1030, configured to control processor 1010 as well as a special-purpose processor where software instructions are incorporated into the actual processor design. Processor 1010 may essentially be a completely self-contained computing system, containing multiple cores or processors, a bus, memory controller, cache, etc. A multi-core processor may be symmetric or asymmetric.

To enable user interaction, computing system 1000 includes an input device 1045, which may represent any number of input mechanisms, such as a microphone for speech, a touch-sensitive screen for gesture or graphical input, keyboard, mouse, motion input, speech, etc. Computing system 1000 may also include output device 1035, which may be one or more of a number of output mechanisms. In some instances, multimodal systems may enable a user to provide multiple types of input/output to communicate with computing system 1000.

Computing system 1000 may include communications interface 1040, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1040 may also include one or more Global Navigation Satellite System (GNSS) receivers or transceivers that are used to determine a location of the computing system 1000 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1030 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 1030 may include software services, servers, services, etc., that when the code that defines such software is executed by the processor 1010, it causes the system to perform a function. In some embodiments, a hardware service that performs a particular function may include the software component stored in a computer-readable medium in connection with the necessary hardware components, such as processor 1010, connection 1005, output device 1035, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the embodiments and examples provided herein, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

For clarity of explanation, in some instances the present technology may be presented as including individual functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual embodiments may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some embodiments the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods, algorithms, and/or operations described above. The computer-readable data storage medium may form part of a computer program product, which may include packaging materials. The computer-readable medium may include memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B.

Illustrative aspects of the disclosure include:

Aspect 1. A method of wireless communications at a first network entity associated with a test equipment vendor, the method comprising: receiving, at the first network entity, information specifying at least one of a type of machine learning model to use for a machine learning decoder, one or more parameters for the machine learning decoder, or one or more key performance indicators for the machine learning decoder; receiving, at the first network entity, a representation of control information from a second network entity; and processing, using the machine learning decoder configured based on the received information, the representation of the control information to generate a reconstruction of the control information.

Aspect 2. The method of Aspect 1, wherein the control information comprises channel state information (CSI) or channel state feedback (CSF).

Aspect 3. The method of any one of Aspects 1 or 2, wherein the information specifies the type of machine learning model to use for the machine learning decoder.

Aspect 4. The method of Aspect 3, wherein the information further specifies the one or more parameters for the machine learning decoder.

Aspect 5. The method of any one of Aspects 1 or 2, wherein the information specifies the type of machine learning model to use for the machine learning decoder and the one or more key performance indicators for the machine learning decoder.

Aspect 6. The method of any one of Aspects 1 or 2, wherein the information specifies the one or more key performance indicators for the machine learning decoder.

Aspect 7. The method of any one of Aspects 1 to 6, further comprising: determining, at the first network entity, a quality of the reconstruction of the control information based on the one or more key performance indicators.

Aspect 8. The method of any one of Aspects 1 to 7, further comprising: determining, based on the reconstruction of the control information, at least one of a precoding matrix or a rank of one or more antennas of the first network entity.

Aspect 9. The method of Aspect 8, further comprising: determining, at the first network entity, a performance quality of the second network entity based on a comparison of least one of the precoding matrix or the rank to at least one of a reference precoding matrix or a reference rank.

Aspect 10. The method of Aspect 9, wherein the performance quality is based on a throughput gain.

Aspect 11. The method of any one of Aspects 1 to 10, further comprising: configuring, at the first network entity, the machine learning decoder based on the information.

Aspect 12. The method of any one of Aspects 1 to 11, further comprising: training the machine learning decoder using data based on a set of profiles specified for the data.

Aspect 13. The method of Aspect 12, wherein the set of profiles for the data comprises one or more parameters associated with at least one of a propagation channel condition, an antenna configuration for the first network entity, or a device type.

Aspect 14. The method of any one of Aspects 12 or 13, wherein the data is comprised of multiple sets of data from a plurality of vendors, each set of data of the multiple sets of data being provided by a respective vendor of the plurality of vendors.

Aspect 15. The method of any one of Aspects 12 to 14, wherein the information specifies a single type of machine learning model to use for the machine learning decoder for all profiles in the set of profiles.

Aspect 16. The method of any one of Aspects 12 to 14, wherein the information specifies a first type of machine learning model to use for the machine learning decoder for at least a first profile in the set of profiles and a second type of machine learning model to use for the machine learning decoder for at least a second profile in the set of profiles.

Aspect 17. The method of any one of Aspects 12 to 14, wherein the information specifies a separate type of machine learning model to use for the machine learning decoder for each profile in the set of profiles.

Aspect 18. The method of any one of Aspects 1 to 17, wherein a machine learning encoder of the second network entity is trained using data generated based on the machine learning decoder of the first network entity.

Aspect 19. The method of any one of Aspects 1 to 18, wherein the representation of the control information is a latent representation of the control information.

Aspect 20. The method of Aspect 19, wherein the latent representation of the control information comprises a feature vector representing the control information.

Aspect 21. The method of any one of Aspects 19 or 20, wherein the latent representation of the control information is received from a machine learning encoder of the second network entity.

Aspect 22. The method of any one of Aspects 1 to 21, wherein the machine learning decoder includes a neural network architecture.

Aspect 23. The method of any one of Aspects 1 to 22, wherein the first network entity is a test equipment emulating a base station and the second network entity is a user equipment (UE).

Aspect 24. The method of any one of Aspects 1 to 23, further comprising: receiving a key performance indicator range associated with a second network entity, the key performance indicator range being associated with a throughput enhancement requirement.

Aspect 25. The method of Aspect 24, wherein the first network entity is a base station and the second network entity is a user equipment (UE).

Aspect 26. A first network entity associated with a test equipment vendor, the first network entity comprising: at least one memory; and at least one processor coupled to the at least one memory and configured to: receive information specifying at least one of a type of machine learning model to use for a machine learning decoder, one or more parameters for the machine learning decoder, or one or more key performance indicators for the machine learning decoder; receive a representation of control information from a second network entity; and process, using the machine learning decoder configured based on the received information, the representation of the control information to generate a reconstruction of the control information.

Aspect 27. The first network entity of Aspect 26, wherein the control information comprises channel state information (CSI) or channel state feedback (CSF).

Aspect 28. The first network entity of any one of Aspects 26 or 27, wherein the information specifies the type of machine learning model to use for the machine learning decoder.

Aspect 29. The first network entity of Aspect 28, wherein the information further specifies the one or more parameters for the machine learning decoder.

Aspect 30. The first network entity of any one of Aspects 26 or 27, wherein the information specifies the type of machine learning model to use for the machine learning decoder and the one or more key performance indicators for the machine learning decoder.

Aspect 31. The first network entity of any one of Aspects 26 or 27, wherein the information specifies the one or more key performance indicators for the machine learning decoder.

Aspect 32. The first network entity of any one of Aspects 26 to 31, wherein the at least one processor is configured to: determine a quality of the reconstruction of the control information based on the one or more key performance indicators.

Aspect 33. The first network entity of any one of Aspects 26 to 32, wherein the at least one processor is configured to: determine, based on the reconstruction of the control information, at least one of a precoding matrix or a rank of one or more antennas of the first network entity.

Aspect 34. The first network entity of Aspect 33, wherein the at least one processor is configured to: determine a performance quality of the second network entity based on a comparison of least one of the precoding matrix or the rank to at least one of a reference precoding matrix or a reference rank.

Aspect 35. The first network entity of Aspect 34, wherein the performance quality is based on a throughput gain.

Aspect 36. The first network entity of any one of Aspects 26 to 35, wherein the at least one processor is configured to: configure the machine learning decoder based on the information.

Aspect 37. The first network entity of any one of Aspects 26 to 36, wherein the at least one processor is configured to: train the machine learning decoder using data based on a set of profiles specified for the data.

Aspect 38. The first network entity of Aspect 37, wherein the set of profiles for the data comprises one or more parameters associated with at least one of a propagation channel condition, an antenna configuration for the first network entity, or a device type.

Aspect 39. The first network entity of any one of Aspects 37 or 38, wherein the data is comprised of multiple sets of data from a plurality of vendors, each set of data of the multiple sets of data being provided by a respective vendor of the plurality of vendors.

Aspect 40. The first network entity of any one of Aspects 37 to 39, wherein the information specifies a single type of machine learning model to use for the machine learning decoder for all profiles in the set of profiles.

Aspect 41. The first network entity of any one of Aspects 37 to 39, wherein the information specifies a first type of machine learning model to use for the machine learning decoder for at least a first profile in the set of profiles and a second type of machine learning model to use for the machine learning decoder for at least a second profile in the set of profiles.

Aspect 42. The first network entity of any one of Aspects 37 to 39, wherein the information specifies a separate type of machine learning model to use for the machine learning decoder for each profile in the set of profiles.

Aspect 43. The first network entity of any one of Aspects 26 to 42, wherein a machine learning encoder of the second network entity is trained using data generated based on the machine learning decoder of the first network entity.

Aspect 44. The first network entity of any one of Aspects 26 to 43, wherein the representation of the control information is a latent representation of the control information.

Aspect 45. The first network entity of Aspect 44, wherein the latent representation of the control information comprises a feature vector representing the control information.

Aspect 46. The first network entity of any one of Aspects 44 or 45, wherein the latent representation of the control information is received from a machine learning encoder of the second network entity.

Aspect 47. The first network entity of any one of Aspects 26 to 46, wherein the machine learning decoder includes a neural network architecture.

Aspect 48. The first network entity of any one of Aspects 26 to 47, wherein the first network entity is a test equipment emulating a base station and the second network entity is a user equipment (UE).

Aspect 49. The first network entity of any one of Aspects 26 to 48, wherein the at least one processor is configured to: receive a key performance indicator range associated with a second network entity, the key performance indicator range being associated with a throughput enhancement requirement.

Aspect 50. The first network entity of Aspect 49, wherein the first network entity is a base station and the second network entity is a user equipment (UE).

Aspect 51. A non-transitory computer-readable storage medium comprising instructions stored thereon which, when executed by at least one processor, causes the at least one processor to perform operations according to any of Aspects 1-25.

Aspect 52. An apparatus for wireless communications comprising one or more means for performing operations according to any of Aspects 1-25.

Aspect 44. A non-transitory computer-readable storage medium comprising instructions stored thereon which, when executed by at least one processor, causes the at least one processor to perform operations according to any of Aspects 1-25.

Aspect 45. An apparatus for wireless communications comprising one or more means for performing operations according to any of Aspects 1-25.

1. A method of wireless communications at a first network entity associated with a test equipment vendor, the method comprising:
receiving, at the first network entity, information specifying at least one of a type of machine learning model to use for a machine learning decoder, one or more parameters for the machine learning decoder, or one or more key performance indicators for the machine learning decoder;
receiving, at the first network entity, a representation of control information from a second network entity; and
processing, using the machine learning decoder configured based on the received information, the representation of the control information to generate a reconstruction of the control information.

2. The method of claim 1, wherein the control information comprises channel state information (CSI) or channel state feedback (CSF).

3. The method of claim 1, wherein the information specifies the type of machine learning model to use for the machine learning decoder, and wherein the information further specifies the one or more parameters for the machine learning decoder.

4. (canceled)

5. The method of claim 1, wherein the information specifies the type of machine learning model to use for the machine learning decoder and the one or more key performance indicators for the machine learning decoder, wherein the information specifies the one or more key performance indicators for the machine learning decoder.

6. (canceled)

7. The method of claim 1, further comprising:
determining, at the first network entity, a quality of the reconstruction of the control information based on the one or more key performance indicators.

8. The method of claim 1, further comprising:
determining, based on the reconstruction of the control information, at least one of a precoding matrix or a rank of one or more antennas of the first network entity.

9. The method of claim 8, further comprising:
determining, at the first network entity, a performance quality of the second network entity based on a comparison of least one of the precoding matrix or the rank to at least one of a reference precoding matrix or a reference rank.

10. The method of claim 9, wherein the performance quality is based on a throughput gain.

11. The method of claim 1, further comprising:
configuring, at the first network entity, the machine learning decoder based on the information.

12. The method of claim 1, further comprising:
training the machine learning decoder using data based on a set of profiles specified for the data.

13. The method of claim 12, wherein the set of profiles for the data comprises one or more parameters associated with at least one of a propagation channel condition, an antenna configuration for the first network entity, or a device type.

14. The method of claim 12, wherein the data is comprised of multiple sets of data from a plurality of vendors, each set of data of the multiple sets of data being provided by a respective vendor of the plurality of vendors.

15. The method of claim 12, wherein the information specifies a single type of machine learning model to use for the machine learning decoder for all profiles in the set of profiles.

16. The method of claim 12, wherein the information specifies a first type of machine learning model to use for the machine learning decoder for at least a first profile in the set of profiles and a second type of machine learning model to use for the machine learning decoder for at least a second profile in the set of profiles.

17. The method of claim 12, wherein the information specifies a separate type of machine learning model to use for the machine learning decoder for each profile in the set of profiles.

18. The method of claim 1, wherein a machine learning encoder of the second network entity is trained using data generated based on the machine learning decoder of the first network entity.

19. The method of claim 1, wherein the representation of the control information is a latent representation of the control information.

20. The method of claim 19, wherein the latent representation of the control information comprises a feature vector representing the control information.

21-25. (canceled)

26. A first network entity associated with a test equipment vendor, the first network entity comprising:
at least one memory; and
at least one processor coupled to the at least one memory and configured to:
receive information specifying at least one of a type of machine learning model to use for a machine learning decoder, one or more parameters for the machine learning decoder, or one or more key performance indicators for the machine learning decoder;
receive a representation of control information from a second network entity; and
process, using the machine learning decoder configured based on the received information, the representation of the control information to generate a reconstruction of the control information.

27. The first network entity of claim 26, wherein the control information comprises channel state information (CSI) or channel state feedback (CSF).

28-52. (canceled)
